(19) United States
(12) Patent Application Publication
(10) Pub. No.: US 2004/0083159 A1
(43) Pub. Date: Apr. 29, 2004

(54) Systems and methods for facilitating settlement of cross-border securities transactions

(76) Inventors: C. Steven Crosby, Westport, CT (US); Edward R. Merchant, Wayne, NJ (US)

Correspondence Address: MORGAN, LEWIS & BOCKIUS LLP, 1701 Market Street, Philadelphia, PA, 19103, US

(21) Appl. No.: 10/461,929

(22) Filed: Jun. 13, 2003

Related U.S. Application Data
(63) Continuation of application No. 09/358,025, filed on Jul. 21, 1999, now abandoned.

(51) Int. Cl. G06F 17/60

(52) U.S. Cl. 705/37

(57) ABSTRACT

Systems and methods for facilitating settlement of a securities transaction. A communications mechanism is adapted to accept incoming electronic messages related to the securities transaction. A processing mechanism, coupled to the communications mechanism, determines compatibility between any two or more incoming electronic messages. The processing mechanism transmits an indication message over the communications mechanism that specifies at least one of: (i) compatibility between any two or more incoming electronic messages; and (ii) incompatibility between any two or more incoming electronic messages.

### BACKGROUND OF THE INVENTION

1. Field of the Invention

This invention relates generally to financial data processing and, more particularly, to systems and methods for facilitating settlement of international, cross-border securities transactions.

2. Background Art

Securities transactions which transcend national boundaries are an important and increasing component of worldwide finance. Securities issuers, custodians, fiduciaries, buyers, sellers and their representatives, and others involved in any particular securities transaction can be located virtually anywhere.

International, cross-border securities trades fail and are not completed (i.e., do not “settle”) far more frequently than domestic trades—and far more often than is desirable to satisfy financial assurance and liquidity objectives. Causes of cross-border trade failure are varied, and include incompatible views of the parties as to bargain specifics, as well as incompatible assumptions and practices regarding settlement mechanics and timing. Beyond impeding investment liquidity, presently-utilized settlement procedures are burdensome and case-dependent, significantly adding to the expense and complexity of completing a trade.

International securities transactions typically involve institutional principals (mutual funds, banks, pension funds as representative) rather than retail (individual) participants. An agent (Broker/Dealer or Investment Manager) acts for the ultimate buying and selling entities. Securities holdings are most often identified as a book entry in the computer records of a custodian which either itself, or via a further custodian, holds the underlying securities in its own or a nominee's name. Settlement of an international security transaction typically requires “delivery” via appropriate book entry adjustments and physical delivery of the security involving at least one and typically often more than one Global Custodian or Sub-Custodian.

In some instances, cross-border trades may not involve an exchange (e.g., the New York Stock Exchange, the London Stock Exchange, the Paris Bourse), whereupon the accompanying exchange-mandated settlement procedures and member firm settlement assurances are no longer applicable. Cross-border trades which do not utilize an exchange are essentially bargains directly or indirectly negotiated between an Investment Manager, Broker/Dealer, or the like, where each party to the trade issues the respective confirmatory notices and settlement instructions.

In the United States, two centralized security clearing corporations are the National Securities Clearing Corporation (NSCC) and the Government Securities Clearing Corporation (GSCC). Specialized clearing agencies exist for international securities as, for example, the International Securities Clearing Corporation (ISCC). The ISCC is a US-based international clearing agency registered with the Securities and Exchange Commission (SEC) to provide clearance, settlement, and information services to participants trading in overseas markets.

Cross-border securities transactions typically involve multiple tiers of intermediary parties, and many investors may be unaware of the existence of some or all of these intermediaries. Managing the inherent risks of a cross-border securities transaction becomes increasingly difficult as the number of tiers increases. As the security instrument is transferred from one intermediary to another, each intermediary in the chain effects the transfer in the form of a book-keeping entry. Typically, the investor does not receive any piece of paper evidencing ownership in such a security, and must rely upon a series of bookkeeping records to establish his interest in the security.

As noted above, much can (and too often does) go wrong during the post trade, pre-settlement phase of a securities transaction. Misunderstandings related to the terms of the bargain are overlooked (at least initially) in crossed messages. Parties can have different expectations as to applicable costs, taxes, risk apportionment, and the priority and sequence of performance. “Delivery” between Global Custodians may not occur (or not be achievable in the requisite timing) for lack of needed information about the transaction and/or a lack of compatibility between the information exchanged between or among the parties.

As a consequence of the foregoing factors the costs and risks of successfully completing cross-border securities transactions is increased. Even if the deal is not successfully completed, the parties are typically burdened with various transactional expenses (e.g., repair costs and fail financing). Moreover, present cross-border trading is not readily amenable to next day settlement (“T+1”), which is the desideratum of all capital markets so as to promote liquidity and to reduce risk.

### SUMMARY OF THE INVENTION

One object of the invention is to accelerate the flow of information between parties participating in a cross-border securities transaction so as to decrease the length of a trade settlement cycle to as short as possible, preferably no greater than the next business day after trade (T+1).

A further object of the invention is to reduce cross-border trade failures by providing accurate and timely information to all parties participating in a cross-border securities transaction.

In summary, a timely, efficient, cross-border securities transaction is facilitated by using a communications mechanism and a processing mechanism to assess the compatibility of incoming information related to a securities transaction, and to provide one or more notification messages indicative of information compatibility. More specifically, the communications mechanism receives incoming electronic messages setting forth one or more parameter values related to a securities transaction. These messages may be received in the form of Notices of Execution (NOEs). Messages are received from a plurality of parties to the transaction, including two or more brokers and one or more custodians. A processing mechanism, coupled to the communications mechanism, first determines which messages of a plurality of incoming messages pertains to a given securities transaction. After identifying two or more messages that pertain to a given securities transaction, the processing mechanism tests for matches between one or more parameter values of these two or more messages. The processing mechanism transmits a message over the communications mechanism specifying at least one of: (i) the existence of matches between one or more parameter values of any two or more incoming electronic messages; and (ii) the non-existence of matches between one or more parameter values of any two or more incoming electronic messages.

According to one preferred embodiment of the invention, incoming messages are received in the form of NOEs specifying any of the following exemplary types of data: (1) a total quantity and value allocation for the securities transaction; (2) a block trade amount for the securities transaction; (3) net proceeds expected by that party from the securities transaction; (4) maximum acceptable deviation from the net proceeds of the securities transaction that a party will accept; and (5) settlement location and/or venue. At a plurality of times during the post-trade, pre-settlement phase of a securities transaction, the processing mechanism determines whether two or more received NOEs pertain to a given securities transaction and, if so, the processing mechanism subjects this data to the above-described matching process. If the processing mechanism determines that all or a subset of parameter values for a given securities transaction match, it signifies that all such terms of the transaction have been agreed to by all or a subset of the parties. When all parameters of all parties are in agreement, the transaction is then forwarded to the local market for settlement. Thereafter, the processing mechanism sends a message to all parties to the transaction notifying them of the final terms of the bargain.

### BRIEF DESCRIPTION OF THE DRAWINGS

FIG. 1 is a hardware block diagram showing an illustrative operational environment for the present invention.

FIGS. 2A, 2B, and 2C together comprise a flowchart setting forth an operational sequence performed by a preferred embodiment of the invention.

FIG. 3 is a data structure diagram utilized by the operational sequence of FIGS. 2A, 2B, and 2C.

### DETAILED DESCRIPTION OF THE PREFERRED EMBODIMENTS

The invention facilitates the timely, efficient settlement of cross-border securities transactions by providing multilateral communications between buyer(s) and seller(s) during the post-trade, pre-settlement phase of the transaction. Typically the parties (buyer(s) and seller(s)) are institutional investors represented by an Investment Manager and/or a Broker/Dealer, and the physical security being traded is held by a Global Custodian or Sub-Custodian. Although these terms well-understood by those skilled in the art of electronically-facilitated securities transactions, they are briefly defined herein for the convenience of the reader. Global custodians and sub-custodians are entities which hold the physical certificate(s) evidencing ownership of a security for the benefit of third parties; for purposes of this invention, a custodian holds the security of the seller(s) and, after the transaction is consummated, the buyer(s) may have a different custodian to which the physical security is transferred. Investment Managers are charged with the responsibility of managing an investment portfolio which may include domestically-issued, as well as foreign-issued, security instruments. A Broker/Dealer (“broker” hereinafter) acts as an interface or liaison between entities that wish to buy and/or sell securities instruments. Depending upon the particular parties on a side of a given securities transaction, any party could be conceptualized as a “seller” of a securities instrument, with any one or more of the remaining “non-selling” parties functioning as a “buyer” of the securities instrument. While the present system can be used to trade anything from stocks to stock cars, as used herein, the term “securities” includes all types of intangible assets, including stocks, bonds, options, derivatives of any kind, and the like.

In the environment of a typical exchange, such as the New York Stock Exchange, NASDAQ, the London Stock Exchange, or the Paris Bourse, transactions are typically handled between brokers or specialists. For example, an institutional investor's investment manager at a brokerage desiring to purchase 10,000 shares of XYZ Company places an order for the same, and a broker (or specialist) finds a broker who wishes to sell essentially the same quantity of shares, and the brokers consummate the transaction. If there is a miscommunication between the brokers as to price or quantity (for example), the buyer and seller are each insulated from this problem by the rules of the exchange; e.g., if the buyer only wanted to purchase 1,000 shares and the buying broker, as in this case, accidentally purchased 10,000, the broker (or the brokerage house) would be responsible for the remaining 9,000 shares. These safeguards are often lacking in cross-border transactions.

For the sake of simplicity, assume that two brokers are conducting a given securities transaction by representing, respectively, a buyer (B/broker) and a seller (S/broker). B/broker and S/broker communicate their desired transactions to each other using conventional communication techniques such as telephony, mail (including courier-delivered and facsimile-transmitted), electronic mail, electronic direct file transfer, and/or other means. Eventually, they will agree upon the parameters of the transaction. Typical parameter values for a securities transaction are: the identity of the security (SID); the number of shares (SHRNO); and the share price (SHR$). In addition to these, because the present invention contemplates transactions across borders, additional variables may include transfer, excise, or other taxes the seller's (and/or buyer's) nation may impose on the transfer of a security (TRTX$). Because S/broker and B/broker are in different countries, they can decide, during the course of negotiations, on the currency B/broker must deliver or tender (BTENDCUR); the seller can also specify a particular currency (STENDCUR). The currency requested by the seller may not be the currency of the seller's domicile, although the security typically will be quoted in the currency of the seller's domicile; for example, many financial markets use United States dollars because it is typically used as a standard currency value throughout the world. Thus, the buyer's currency type (BCUR), the currency in which the security is quoted (SECCUR), and the exchange rates between (i) the buyer's currency and that tendered (XBCUR) and (ii) the security currency and that tendered (XSECCUR) may all have to be specified so that the transaction intended is well-defined and understandable to all involved. Of course, the system must also identify B/broker (BBRID) and S/broker (SBRID) to track each of the foregoing parameters as defined or offered by each party. Clearly, other and/or additional parameters can be specified as well; for example, an alternative settlement venue.

In addition to items such as alternative settlement venues, currency and exchange rates, other issues may arise in cross-border securities transactions. Differences in exchange rates, expectations as to tax rates, transfer fees, and other factors may likely render an exact meeting of price and quantity impossible. Accordingly, in a preferred embodiment the parties specify a tolerance for one or more parameters within which a matching parameter from the other will be accepted. As another example, a party may wish to buy or sell a large block of securities for which it may be difficult and/or time-consuming to secure counterparties to the transaction. Accordingly, the transaction may have to be divided into a number of separate transactions; for example, a holder of 1,000,000 shares may have to sell ten blocks of 100,000 shares each because there is no ready buyer for all of the seller's shares.

In practice, this invention is a post-transaction, pre-settlement system that facilitates the information exchange to reach the agreement necessary to settle the transaction. Assume a buyer in the US desired to purchase 1000 shares of XYZ Co. traded in India; based on available information, the buyer is willing to purchase the shares at US$ 10.00 each. B/broker makes contact with and communicates (by voice, facsimile, and the like) this information to S/broker. Assume that S/broker agrees to these terms. The transaction is now specified, and the two brokers preferably (hopefully) will communicate at least these details of the trade to each other so that they have confirmation of the agreement. Now, in the post-trade, pre-settlement phase, each of the brokers communicates to the present system the parameter values mentioned above; e.g., SHRNO, SHR$, BBRID, SBRID, TENDCUR, and the like. Each or all of these parameters can be transmitted to the system by a Notice of Execution (NOE), initiated by the buyer and/or the seller. Once the system receives an NOE, it identifies the particular transaction (such as by assigning a unique identifier) and accepts values for the parameters sent by the brokers in the form of further NOEs. Preferably, the identifier is communicated to the brokers so that future communications, such as the transmission of values for other parameters, can be accurately mapped to the information already stored in the system about the subject trade.

As mentioned above, preferably both of the brokers specify a tolerance for certain parameters. For example, the buyer may be willing to purchase a given number of shares at US$ 9.90 to US$ 10.10; the seller may be willing to sell the given number of shares at a price not less than equivalent to US$ 9.95. The present system accepts each of the values transmitted and stores them to determine whether commensurate variables have been consistently specified by each broker and, if tolerances are identified for the total net proceeds and/or receipts of the deal, whether the values fall within the specified tolerances. Note that the concept of tolerances arises only in connection with monetary values, such as the total net proceeds due and/or received for a given securities transaction, and tolerance values are not generally applied to individual non-monetary components of the securities transaction.

Because B/broker in the present example resides in the US, the system can be programmed to enter a default value for BTENDCUR of US dollars, and Rupees for STENDCUR. If S/broker specifies STENDCUR as US dollars and B/broker does not specify this parameter, the system then indicates to both brokers that the values they have indicated for TENDCUR are compatible between them, namely US dollars. When a tolerance is specified, the system will indicate to the brokers that the SHRNO and SHR$ are compatibly specified if, at least, the values specified by one fall within the other's tolerance. Here, SHR$ will be communicated to the brokers by the system as having a value of US$ 9.95 and SHRNO as having a value of 1050. The brokers need not communicate all of the parameters to the system at once, but the system will store and track each of the brokers' communications as they are received until the information sufficient for settlement has been compatibly specified in the system. Preferably the system will update its communication to both brokers each time a new parameter or value is received by the system. Certain parameters, such as an expected return or payment, can be calculated by the system; such a calculation of expected return or payment can include taxes and fees.

Once all of the parameters have been specified in a compatible manner, the transaction is completed and agreed to by the parties. From a practical point, thereafter, the physical certificate underlying the security, or some other indicia of ownership, must be transferred to the buyer. Typically, an investor does not possess the certificate; it is held by a custodian for the beneficial holder, the brokerage. The brokerage where the broker trades has a book entry identifying the client, the number of shares owned, and the custodian holding the certificates for those shares. After a transaction is completed by this invention, the certificates should be transferred to the buyer.

In practice, the certificate is transferred from one custodian to another, assuming the buyer's and seller's brokerages use different custodians. Custodians may be affiliated with one or more clearing organizations, such as Cedel, Euroclear, or the ISCC. Certain clearing organizations have agreements with other clearing organizations (these agreements are typically referred to as links or bridges) to facilitate the settlement process after a trade. For example, there is a link between a clearing organization known as the Canadian Depository for Securities, Limited (CDS) and US-based DTC (Depository Trust Company). This link, operational for US and certain Canadian issues, provides CDS with full access to US clearance and settlement, including custody services. US-based ISCC (International Securities Clearing Corporation) has a link with the London Stock Exchange (LSE) whereby automated checking comparisons, clearance and settlement services are provided for UK equities, and safe custody of securities is provided through the Citibank Corporation. The Japanese Securities Clearing Corporation has an ISCC-sponsored omnibus account at the DTC (Depository Trust Company) for receipt and delivery of US equity issues listed on the Tokyo and Osaka Stock Exchanges.

A link between ISSC and Cedel Bank of Luxembourg provides for the settlement of various eligible securities, including PORTAL 144A issues, with multi-currency capabilities among Cedel bank participants, other ISCC participants, as well as participants or members of any other national clearing and/or depository system having a link with Cedel Bank such as, for example, Euroclear. The Stock Exchange of Singapore has an omnibus account at the DTC for the receipt and delivery of US NASDAQ issues quoted in the Stock Exchange of Singapore's (SES's) Foreign Equities Market/SESDAQ system on behalf of SES.

Euroclear and ISCC are linked such that ISCC members have input capabilities for Euroclear instructions and cancellations. ISCC accepts instructions from users, reformats the instructions, and then submits them to Euroclear. Finally, a link between ISCC and SD INDEVAL of Mexico provides for the automated communication of instructions to INDEVAL's computer mainframe. This link also provides for clearance and settlement of transactions with Mexican equities, in Mexican Pesos or US Dollars. Settlement confirmations and end-of-day statements are also provided, as well as custody services for Mexican equities, collection of dividends, execution of rights offerings, and proxy voting.

According to one preferred embodiment of the invention, information pertaining to any of the aforementioned links is stored (e.g., in a look-up table, database, and/or data store) with the custodians mapped to one or more clearing organizations and, optionally, one or more brokerages. After the present system notifies the brokers that the transaction has been fully specified and completed, the system references the stored custodian information and notifies all of the custodians about the details of the transaction so that the certificates can be transferred. The look-up table facilitates this communication by notifying custodians having agreements regarding these transfers. In a preferred embodiment, S/broker and/or B/broker also specify to the system a local market settlement time by which the settlement (transfer of assets) must occur. This can be implemented by requiring the seller's custodian to notify the system (or the broker) that the certificates have been transferred before the period specified, and if the system does not receive such a notification, then the system notifies the brokers and the custodians that the agreed upon period for settlement has passed and the transaction has failed to settle. Of course, the brokers (on behalf of the parties) still have an agreement and can consult their respective beneficiaries to inquire whether settlement should still be attempted in spite of the lapse of time.

The present system is also applicable to “electronic” or “dematerialized” securities. These are securities that are only issued in electronic form, and do not have any other physical indicia (such as a stock certificate) specifying the intangible property. Additionally, it may be the case that the security is identified with a certificate in the buyer's country but is a dematerialized security in the seller's country. In such a case, the present system provides instructions to the entity charged with keeping track of the dematerialized security, so that the respective interests of the buyer and the seller are accounted for.

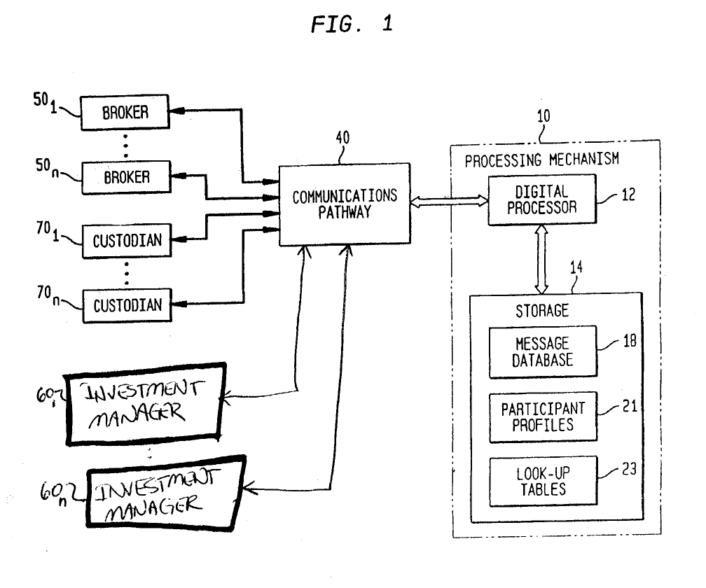

The invention will now be described with reference to the figures. FIG. 1 is an illustrative view of the post-transaction, pre-settlement system according to the present invention. The system includes a processing mechanism 10 illustratively implemented using a processor 12 coupled to storage 14. It is to be understood that processing mechanism 10 may represent a mainframe computer, a personal computer (PC), a computer network, or any other type of centralized and/or distributed processing system. Storage 14 may be non-volatile, such as, for example, a data storage drive, and/or it may be implemented using random-access memory (RAM), read-only memory (ROM), and/or core memory. Storage 14 preferably may be arranged to store messages from the brokers in a message database (DB) 18, and may also be arranged to provide additional storage areas for participant profiles 21 (e.g., the brokers) as well as look-up tables 23. Messages (such as an NOE message) are received by the system, and transmitted from the system to the participants, via a communications pathway 40. Communications pathway 40 may represent any technique for conveying information from one place to another, including, for example, wireless communications, wired communications, and/or fiber optic links, to name a few. The information may be conveyed using any of a wide variety of transmission protocols, including digital and/or analog data signals (which could, but need not, be encrypted or otherwise securely transmitted), voice (which may also be encrypted), mail (including postal, facsimile, and electronic correspondence, the latter two of which can also be encrypted for security). Brokers 50₁ through 50ₙ communicate with the system via the communications pathway 40, as do custodians 70₁ through 70ₙ, and investment managers 60₁ through 60ₙ. At least one broker is required, and at least one custodian is required. Typically, at least one investment manager is also involved. The communications pathway 40 may include one or more dedicated wired and/or wireless communication links between the present system and the brokers and/or custodians. It may also include a network by which the brokers, and custodians, can interface with the system. Such a network can have local areas (e.g., a LAN) and/or span a wider area (e.g., a WAN, optionally with satellite communication and/or radio frequency communication). Another preferred network is the internet, where secure communication can be conducted using secure hypertext transfer protocol (i.e., via a private network).

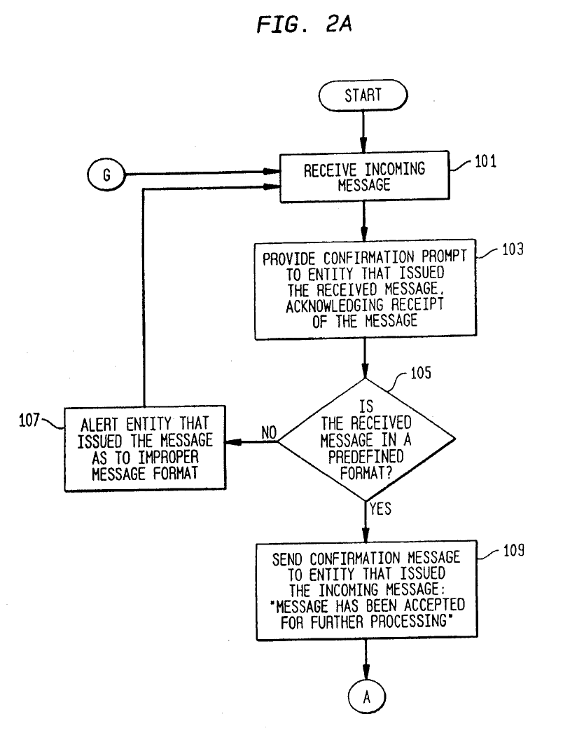

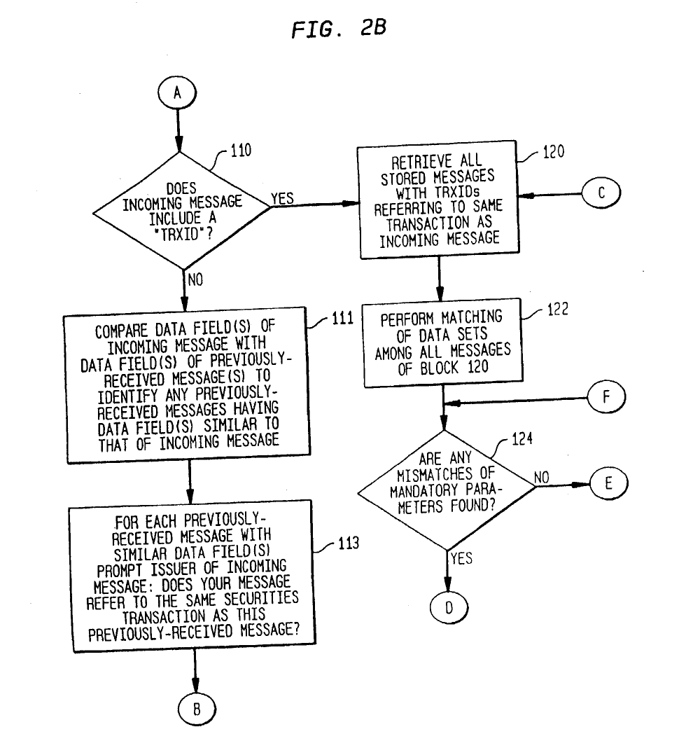

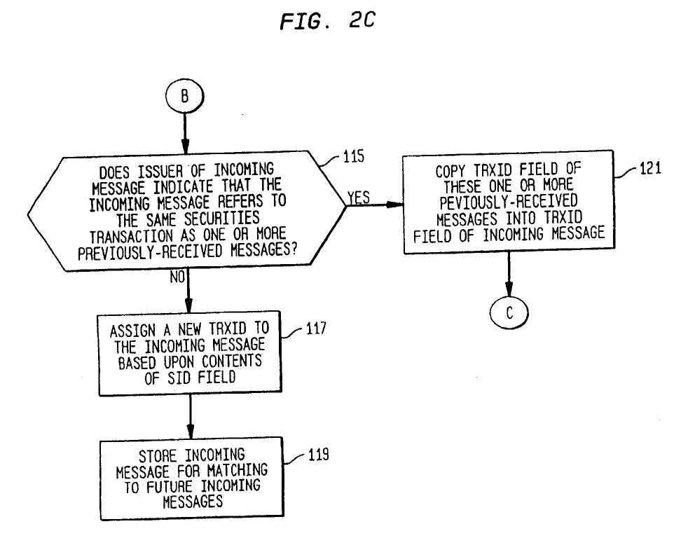

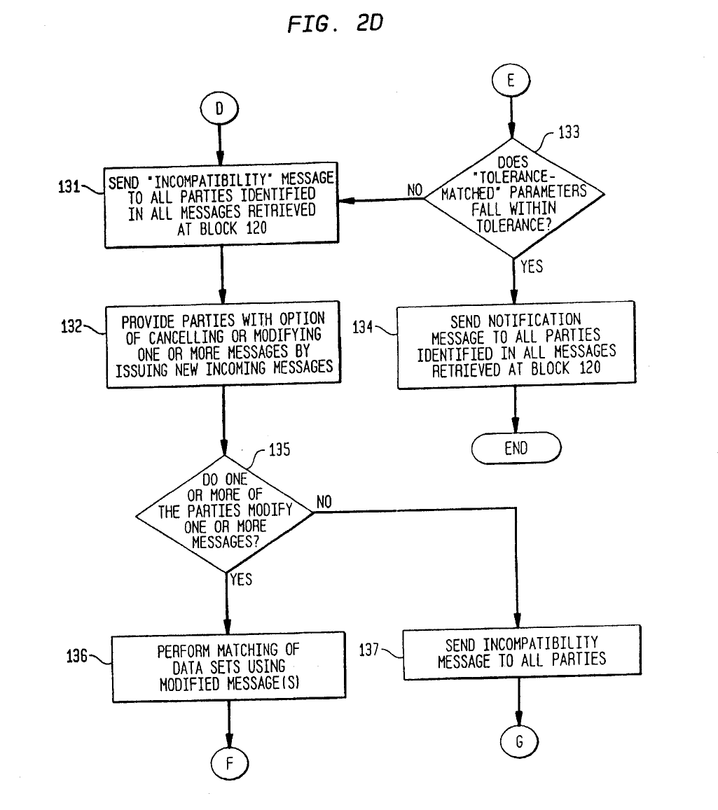

Refer now to FIGS. 2A, 2B, and 2C which together comprise a flowchart setting forth an operational sequence performed according to a preferred embodiment of the invention. The overall operational sequence describes the manner in which the system of FIG. 1 provides multilateral communications between a first broker 50₁, a second broker 50₂, one or more investment managers 60₁ through 60ₙ and a custodian 70₁. More specifically, the system of FIG. 1 provides multilateral communications in response to the receipt of one or more messages from at least one of the first broker 50₁, second broker 50₂, investment manager 60₁ and custodian 70₁.

The program of FIGS. 2A, 2B, and 2C commences at block 101 where an incoming message is received from any of the aforementioned parties. In general, an incoming message may specify any of the following exemplary types of data: (1) a total quantity and value allocation for the securities transaction, (2) a block trade amount for the securities transaction, (3) net proceeds of the securities transaction, (4) maximum acceptable deviation from the net proceeds of the securities transaction, and (5) settlement location and/or venue. The message may also includes a transaction ID (TRXID) uniquely identifying a given securities transaction.

The incoming message may be organized as shown in the data structure table below, wherein the variables are those which were previously discussed in conjunction with the illustrative cross-border securities transaction. For example, the buyer may first initiate an illustrative message with the following values:

| TRXID | BBRID | SID | SHRNO | SHR$ | SHR$TOL |
|---|---|---|---|---|---|
| 13424 | ML123 | ATT | 1000 | 100 | 2 |

where TRXID is the transaction ID, BBRID is the identity of the buyer's broker, SID is the identity of the security, SHRNO is the number of shares, SHR$ is the share price, and SHR$TOT is the maximum deviation (plus and minus) from the share price that the buyer is willing to accept. This message does not have to include all of these fields, and it could also include additional fields such as BTENDCUR, specifying the buyer's tender currency, TRTX$, specifying tax to be levied on the transaction.

Subsequent to issuance of the buyer's message, the seller will issue a message. Note that, alternatively, the seller could initiate a message first. An illustrative example of a message issued by a seller is:

| TRXID | SBRID | SID | SHRNO | SHR$ | SHR$TOL |
|---|---|---|---|---|---|
| 13424 | SB555 | ATT | 1200 | 105.9 | 7.5 |

At block 103, the program provides a confirmation prompt to the entity issuing the received message, which may be first broker 50₁, second broker 50₂, or custodian 70₁, acknowledging that the message has been received.

At block 105, the program checks to ascertain whether or not the received message conforms to a predefined format, examples of which are shown in the data structure tables above. Although any of various message formats may be used to implement the invention, on occasion, data transmission errors may occur, or unauthorized parties may attempt access, and it would be desirable to identify such errors at the present stage, before further processing takes place. If the message does not conform to a predefined format, the entity that issued the message is alerted (block 107), and the program loops back to block 101. If, on the other hand, the message conforms to a predefined format, the message is considered to be an NOE (notice of execution) message, and the program advances to block 109. A confirmation message is sent to the entity that issued the message, conveying the notion that the message has been accepted for further processing.

Next, at block 110, the program must ascertain whether or not the incoming message includes a transaction ID (TRXID) which uniquely specifies a given securities transaction. If not, the program advances to block 111 where the data field(s) of the incoming message are compared with the data field(s) of previously received message(s) to identify any previously received message(s) having data field(s) similar to that of the incoming message. Next, at block 113, for each previously received message with similar data field(s), the issuer of the incoming message is prompted as follows: “does your message refer to the same securities transaction as the previously received message?” The program then advances to block 115 where a test is performed to determine whether or not the issuer of the incoming message has indicated that the incoming message refers to the same securities transaction as one or more previously received messages. If so, the TRXID field(s) of these one or more previously received messages is/are copied into the TRXID field of the incoming message (block 121), and the program loops back to block 120.

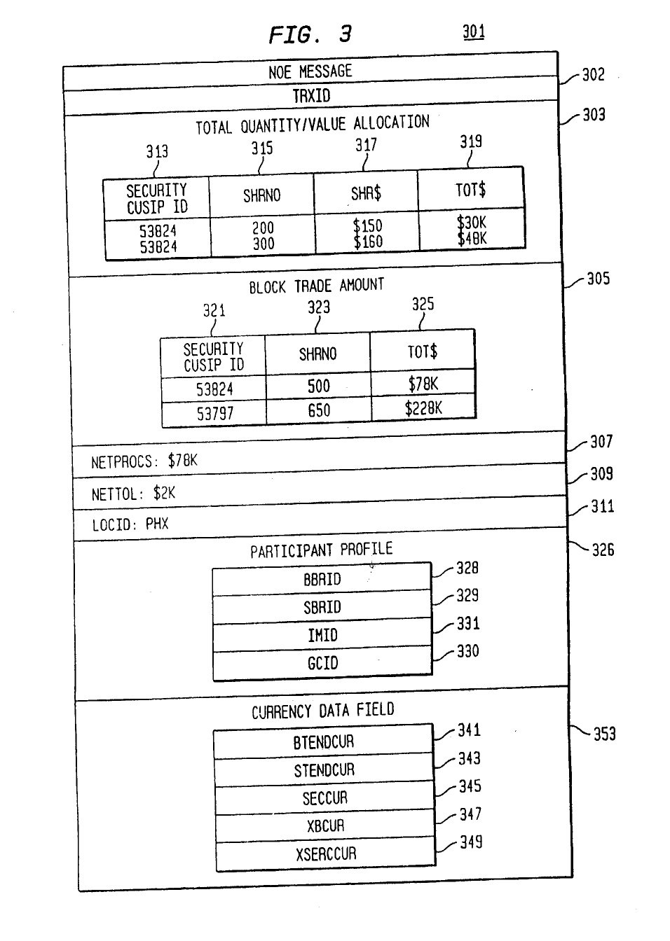

Block 120, reached upon execution of the affirmative branch of block 110, or from block 121, retrieves all stored messages with TRXIDs referring to the same securities transaction as the incoming message. Next, at block 122, a matching process is performed to match data sets among all messages which were retrieved at block 120, including the matching of these data sets with data sets of the incoming message. At block 124, a test is performed to ascertain whether or not any mismatches of mandatory parameters were found. During this step, the program ascertains whether parameters which must match exactly, such as the identity of the security (SID), do, indeed match. In the illustrative buyer and seller messages given above, the SID fields match because they both specify ATT stock. Illustrative examples of mandatory parameters may, but need not, include parameters such as, for example, the security CUSIP ID (field 313 of FIG. 3), and possibly the LOCID (field 311 of FIG. 3).

The affirmative branch from block 124 leads to block 131 where an “incompatibility” message is sent to all parties identified in all messages retrieved at block 120, as well as to the sender of the incoming message. At block 132, one or more parties are provided with the option of canceling or modifying one or more messages by issuing new incoming messages. The program then advances to block 135 where a test is performed to ascertain whether one or more parties modified one or more messages. If no messages were modified, an incompatibility message is sent to all parties (block 137), and the program loops back to block 101. If, however, one or more messages were modified, the program advances to block 136 where a matching process is performed to match data sets using the modified message(s). The program then loops back to block 124.

The negative branch from block 124 leads to block 133, where a test is performed to ascertain whether or not each of the tolerance-matched parameters fall within a corresponding specified tolerance. Tolerance-matched parameters are parameters that specify money and/or financial consideration, although not all such parameters need to be tolerance-matched. (Note that different parameters may have different specified tolerances, and also that different parties may specify different tolerances for the same parameter). These tolerance matches can be performed on items such as the share price (SHR$) using the tolerance value SHR$TOL specified by each of the parties. The processor checks to see if the values entered by all of the parties are within the tolerance specified by the least-tolerant party. For example, the buyer's message (above) specified a SHR$ of $9.95 whereas the seller's message specified a SHR$ of $9.90. Thus, there is a match within the required tolerance. If, however, one or more of the parameters are out of the tolerance, the program loops back to block 131, previously described. On the other hand, if all of the tolerance based parameters fall within their specified tolerances, the program advances to block 134. A notification message is sent to all parties identified in all messages retrieved at block 120, as well as the sender of the incoming message, confirming various parameters of the securities transaction. The program then ends.

Return for a moment to block 119, where the incoming message was stored for matching to future incoming messages. Once the message is stored, a “no match found yet” flag is set, and a pending transaction file is created/updated. This pending transaction file identifies the incoming data set as waiting to be matched to future incoming data set(s). Finally, an alert message stamped by a centralized reference time clock is sent to the counter-parties identified in the incoming message.

The flowchart of FIGS. 2A-2C describes the process whereby, at any time during the post-trade, pre-settlement process, a matching mechanism accessible from a communications pathway matches data entered into this pathway. The matching process matches any of the following types of data: (1) matching the total quantity and value allocation, as entered by a first party, to the block trade amount, as entered by a second party; (2) matching net proceeds, as entered by a first party, to net proceeds, as entered by a second party; (3) matching maximum acceptable deviation from net proceeds, as entered by a first party, to maximum acceptable deviation from net proceeds, as entered by a second party; and (4) matching the settlement locations and/or venues as entered by all of the parties.

The communications pathway is coupled to an indication mechanism, responsive to the matching mechanism, for providing a first indication as to the existence of a data match and/or the non-existence of a data match. The indication mechanism may include a display for indicating matches and/or mismatches between any of the following: (1) the total quantity/value allocation and the block trade amount, (2) net proceeds, (3) maximum acceptable deviation from net proceeds; and (4) settlement locations and/or venues.

An optional timestamp can be applied to all incoming messages, enabling subsequent determination of settlement efficiencies and any possible settlement bottlenecks. Universal Coordinated Time (UTC), previously known as GMT (Greenwich Mean Time), can be used as the timestamp standard.

FIG. 3 is a data structure diagram setting forth an illustrative NOE (Notice of Execution) message 301 utilized by the operational sequence of FIGS. 2A, 2B, and 2C. The NOE message 301 includes a TRXID field 302 that specifies a given securities transaction, and a data field for storing information related to total quantity/value allocation 303. The total quantity/value allocation 303 field contains a first sub-field for storing the security CUSIP ID 313 for each of a plurality of securities. A second sub-field stores the number of shares SHRNO 315 for one or more of the securities referred to in the security CUSIP ID 313 field, a third sub-field stores the price per share SHR$ 317 for one or more of the securities referred to in the security CUSIP ID 313 sub-field, and a fourth sub-field sets forth the total price TOT$ 319 of the security identified in the associated security CUSIP ID 313 sub-field, based upon the number of shares SHRNO 315 and the price per share SHR$ 317 set forth in the associated sub-fields.

NOE message 301 includes a data field for storing information related to a block trade amount 305. The block trade amount 305 field includes a first sub-field for storing a security CUSIP ID 321 for each of a plurality of securities, a second sub-field for storing the total number of shares SHRNO 323 for one or more of the securities referred to in the CUSIP ID 321 sub-field, and a third sub-field setting forth the total price TOTS 325 of the security identified in the associated security CUSIP ID 321 field based upon the entry in the total number of shares SHRNO 323 sub-field.

Another data field sets forth net proceeds NETPROC 307, a fourth date field specifies an acceptable deviation from net proceeds NETTOL 309, and a fifth data field 311 sets forth a settlement location identifier LOCID 311. A participant profile data block 326 identifies the participants to a given securities transaction, including any of: one or more BBRIDs 328 uniquely identifying one or more buyer's brokers, one or more SBRIDs 329 uniquely identifying one or more seller's brokers, one or more Investment Manager IDs IMIDs 331 and one or more Global Custodian IDs GCIDs 330 uniquely identifying Investment Manager(s) and Global Custodian(s) participating in the securities transaction.

A currency data field 353 sets forth the buyer's tender currency BTENDCUR 341, the seller's tender currency STENDCUR 343, the currency in which the security is quoted SECCUR 345, the exchange rate between the buyer's actual currency and the buyer's tendered currency XBCUR 347, and the exchange rate between the security currency and the security tendered by the buyer XSERCCUR 349 (e.g., this is an example of additional data fields that may effect settlement).

It will be readily seen by one of ordinary skill in the art that the present invention fulfills all of the objects set forth above. After reading the foregoing specification, one of ordinary skill will be able to effect various changes, substitutions of equivalents and various other aspects of the invention as broadly disclosed herein. It is therefore intended that the protection granted hereon be limited only by the definition contained in the appended claims and equivalents thereof.

We claim:

1. A system for facilitating settlement of a securities transaction comprising:
(a) a communications mechanism adapted to receive incoming electronic messages setting forth one or more parameter values related to a securities transaction;
(b) a processing mechanism, coupled to the communications mechanism, and adapted to determine matches between one or more parameter values of any two or more incoming electronic messages;
wherein the processing mechanism is further adapted to transmit an indication message over the communications mechanism, the indication message specifying at least one of: (i) the existence of matches between one or more parameter values of any two or more incoming electronic messages; and (ii) the non-existence of matches between one or more parameter values of any two or more incoming electronic messages.

2. The system of claim 1 wherein one or more respective parameter values are associated with corresponding tolerances setting forth a maximum acceptable deviation for the respective parameter value, and the processing mechanism is further adapted to identify matches between parameter values within the maximum acceptable deviation.

3. The system of claim 1 wherein the communications mechanism is further adapted to accept incoming electronic messages related to a first securities transaction and incoming electronic messages related to a second securities transaction; and
wherein the processing mechanism includes a discrimination mechanism adapted to distinguish incoming electronic messages related to the first securities transaction from incoming electronic messages related to the second securities transaction; the processing mechanism adapted to determine compatibility between two or more incoming electronic messages related to the first securities transaction, and the processing mechanism also adapted to determine compatibility between two or more incoming electronic messages related to the second securities transaction.

4. The system of claim 1 wherein the incoming electronic messages include parameter values specifying at least one of a settlement location or venue; a source allocation for the securities transaction; and an amount of net proceeds for the securities transaction.

5. The system of claim 1 wherein the incoming electronic messages include parameter values specifying at least one of:
(a) a first proposed settlement location,
(b) a first proposed source allocation, and
(c) a first proposed amount of net proceeds,
and parameter values specifying at least one of:
(d) a second proposed settlement location,
(e) a second proposed source allocation, and
(f) a second proposed amount of net proceeds,
wherein the processing mechanism determines compatibility by identifying any matches between the first and second proposed settlement locations, the first and second proposed source allocations, and the first and second proposed amounts of net proceeds.

6. A system for facilitating settlement of a cross-border securities transaction between a first party and a second party, the first party being a seller or a seller's representative and the second party being a buyer or a buyer's representative, the transaction being defined by a plurality of parameters, the system comprising:
an input mechanism adapted for receiving a message from the seller or the seller's representative and a message from the buyer or the buyer's representative, said messages each setting forth at least one value for at least one parameter relating to the transaction;
a processing mechanism comprising a data storage for parameter values and a processor for comparing parameter values for each of a plurality of parameters to identify at least one of compatible and incompatible parameter values; and
a communications mechanism coupled to the processing system for providing an output message indicative of at least one of: (i) identification of compatible parameter values; and (ii) identification of incompatible parameter values.

7. The system of claim 6, wherein a parameter comprises a value and a tolerance for the value.

8. The system of claim 7, wherein the processor determines whether a parameter received from the first party is within the tolerance for the value received from the second party.

9. The system of claim 6, wherein a parameter has a default value.

10. The system of claim 6, wherein a parameter has a default tolerance.

11. The system of claim 6, wherein a parameter identifies the seller or the seller's representative and the buyer or the buyer's representative.

12. The system of claim 6, wherein the processor assigns a unique identifier to a particular transaction.

13. The system of claim 6, wherein a parameter identifies a custodian for the seller's security.

14. The system of claim 13, wherein a parameter further identifies a custodian for receipt of the buyer's security.

15. The system of claim 13, wherein the processing mechanism notifies the custodian for the seller's security and the custodian for receipt of the buyer's security of a consummated transaction.

16. A system for facilitating settlement of a cross-border securities transaction between a seller's representative and a buyer's representative, the transaction being defined by a plurality of parameters, the security being held by a custodian, the system comprising:
a communications mechanism for receiving messages from the seller's representative and the buyer's representative, said messages comprising values for the parameters relating to the transaction;
a processing system comprising data storage for parameter values and notifying the seller's representative and the buyer's representative of the parameters for a consummated transaction; and
an indication mechanism for providing an indication to the communications mechanism which is indicative of one or more parameters for the consummated

17. A method for facilitating settlement of a securities transaction including the steps of:
(a) a communications mechanism receiving incoming electronic messages setting forth one or more parameter values related to a securities transaction;
(b) a processing mechanism for storing said, values and for parameter determining matches between one or more parameter values of any two or more incoming electronic messages;
(c) the processing mechanism transmitting an indication message over the communications mechanism, the indication message specifying at least one of: (i) the existence of matches between one or more parameter values of any two or more incoming electronic messages; and (ii) the non-existence of matches between one or more parameter values of any two or more incoming electronic messages.

18. The method of claim 17 further including the steps of:
(a) the communications mechanism accepting incoming electronic messages related to a first securities transaction and incoming electronic messages related to a second securities transaction;
(b) the processing mechanism distinguishing incoming electronic messages related to the first securities transaction from incoming electronic messages related to the second securities transaction; and
(c) the processing mechanism determining compatibility between two or more incoming electronic messages related to the first securities transaction.

19. The method of claim 18 further including the step of the processing mechanism determining compatibility between two or more incoming electronic messages related to the second securities transaction.

20. The method of claim 17 further including the steps of:
(a) the communications mechanism accepting incoming electronic messages related to a first securities transaction and specifying at least one of:
(a) a first proposed settlement location,
(b) a first proposed source allocation, and
(c) a first proposed amount of net proceeds,
(b) the communications mechanism accepting incoming electronic messages related to the first securities transaction and specifying at least one of:
(d) a second proposed settlement location,
(e) a second proposed source allocation, and
(f) a second proposed amount of net proceeds,
(c) the processing mechanism determining compatibility by identifying any matches between the first and second proposed settlement locations, the first and second proposed source allocations, and the first and second proposed amounts of net proceeds.

21. A post-trade, pre-settlement system for facilitating a securities transaction and comprising:
a. a computer processing mechanism;
b. an interfacing mechanism adapted for interfacing the computer processing mechanism with at least two of the following entities: a seller of a securities instrument, a buyer of the securities instrument, and a holder of the securities instrument;
wherein, in response to the issuance of a notification of execution (NOE) message from the interfacing mechanism, the computer provides multilateral data communications between the at least two entities.

22. The post-trade, pre-settlement system of claim 21 wherein the multilateral data communications includes data specifying at least one of a settlement location or venue; a source allocation for the securities transaction; and an amount of net proceeds for the securities transaction.

23. The post-trade, pre-settlement system of claim 21 wherein, for a first securities transaction, data specifying at least one of:
(a) a first proposed settlement location,
(b) a first proposed source allocation, and
(c) a first proposed amount of net proceeds,
are entered into the interfacing mechanism, and, for the first securities transaction, data specifying at least one of:
(d) a second proposed settlement location,
(e) a second proposed source allocation, and
(f) a second proposed amount of net proceeds,
are entered into the interfacing mechanism;
the computer processing mechanism further including a matching mechanism for identifying any matches between the first and second proposed settlement locations, the first and second proposed source allocations, and the first and second proposed amounts of net proceeds.

24. The post-trade, pre-settlement system of claim 21 wherein the computer further includes a confirmation mechanism for sending a confirmation message to the interfacing mechanism, the confirmation message identifying matches, if any, between the first and second proposed settlement locations, the first and second proposed source allocations, and the first and second proposed amounts of net proceeds.

25. The post-trade, pre-settlement system of claim 24 wherein the interfacing mechanism includes at least a first interface situated within a first region defined with reference to geographic, economic, and/or political boundaries, and a second interface not situated within the first region, so as to facilitate a cross-border securities transaction.

26. The post-trade, pre-settlement system of claim 24 wherein, for a first securities transaction, a first data set specifying at least one of:
(a) a first proposed settlement location,
(b) a first proposed source allocation, and
(c) a first proposed amount of net proceeds,
are entered into the interfacing mechanism, and, for the first securities transaction, a second data set specifying at least one of:
(d) a second proposed settlement location,
(e) a second proposed source allocation, and
(f) a second proposed amount of net proceeds,
are entered into the interfacing mechanism; and
for a second securities transaction, a third data set specifying at least one of:
(a) a first proposed settlement location,
(b) a first proposed source allocation, and
(c) a first proposed amount of net proceeds,
are entered into the interfacing mechanism; and
for the second securities transaction, a fourth data set specifying at least one of:
(d) a second proposed settlement location,
(e) a second proposed source allocation, and
(f) a second proposed amount of net proceeds, are entered into the interfacing mechanism;
the computer processing mechanism further including a matching mechanism for matching the first data set to the second data set, for matching the third data set to the fourth data set, and for identifying any matches, as between the first and second data sets, for the first and second proposed settlement locations, the first and second proposed source allocations, and the first and second proposed amounts of net proceeds.
